(19) United States
(12) Patent Application Publication
(10) Pub. No.: US 2004/0077740 A1
(43) Pub. Date: Apr. 22, 2004

(54) Cellular polyurethane elastomers, a process for preparing these and their use

(76) Inventors: Klaus Brecht, Burscheid (DE); Peter Haas, Haan (DE)

Correspondence Address: BAYER POLYMERS LLC, 100 BAYER ROAD, PITTSBURGH, PA, 15205, US

(21) Appl. No.: 10/683,240

(22) Filed: Oct. 10, 2003

(30) Foreign Application Priority Data
Oct. 14, 2002 (DE) 10247789.2

(51) Int. Cl. C08G 18/00

(52) U.S. Cl. 521/155

(57) ABSTRACT

The present invention is directed to cellular amine-crosslinked polyurethane elastomers, a process for preparing these elastomers and to the production of various parts of shoes and soles of shoes from these elastomers.

### BACKGROUND OF THE INVENTION

The present invention relates to cellular amine-crosslinked polyurethane elastomers, a process for preparing these elastomers and to the production of parts of shoes and soles of shoes from these elastomers.

Polyisocyanates or polyisocyanate prepolymers, polyetherpoyols or polyesterpolyols, chain extenders, blowing agents and other additives are used to prepare polyurethane (PUR) expanded materials. Conventional chain extenders are those of the glycol, aminoalcohol or diamine types. EP-A 1 182 219 describes PUR molded parts for use as soles of shoes. In this case, aromatic diamines are used as chain-extenders, wherein solid molded parts are obtained. The density of these molded parts is very high at 950-1200 kg/m³. For certain applications such as, for example, soles of shoes, it is advantageous to have molded parts with good elastomeric properties and also a cellular structure, i.e. a low bulk density. If diamines are used as chain-extenders and water is used as a blowing agent to produce such cellular elastomers, balancing of the blowing and crosslinking reactions is surprisingly poor. In the presence of water, virtually solid reaction products are obtained. The blowing reaction with water, involving the production of CO₂, apparently plays only a subordinate role in the presence of amine components as chain extenders.

### SUMMARY OF THE INVENTION

An object of the present invention was to provide cellular polyurethane elastomers, which are crosslinked with amines, and also a process for preparing these cellular polyurethane elastomers.

Surprisingly, it was found that the blowing reaction process with water and/or physical blowing agents does take place when a mixture of chain extenders comprising aromatic amines containing at least 2 primary amine groups per molecule, and quaternary ammonium salts, and optionally, diols having molecular weights of ≦400 are used. It is possible to produce cellular elastomers which can be used, for example, as soles of shoes from such formulations.

### DETAILED DESCRIPTION

The present invention is directed to cellular amine-crosslinked polyurethane elastomers comprising the reaction product of

A) one or more compounds selected from the group consisting of polyisocyanates, polyisocyanate prepolymers, modified polyisocyanates and mixtures thereof;

B) one or more polyols selected from the group consisting of polyether polyols, polyester polyols and mixtures thereof;

C) chain-extenders comprising a mixture of:

C1) one or more aromatic amines with at least two primary amine groups per molecule,

C2) one or more quaternary ammonium salts, and,

C3) optionally, one or more short chain diols having molecular weights of no more than 400 g/mol;

in the presence of

D) water and/or physical blowing agents;

E) catalysts; and

F) optionally, additional auxiliary substances and/or additives.

The present invention is also directed to a process for the preparation of cellular amine-crosslinked polyurethane elastomers. This process comprises reacting

A) one or more compounds selected from the group consisting of polyisocyanates, polyisocyanate prepolymers, modified polyisocyanates and mixtures thereof; with

B) one or more compounds selected from the group consisting of polyether polyols, polyester polyols and mixtures thereof; and

C) chain extenders comprising a mixture of:

C1) one or more aromatic amines having at least two primary amine groups per molecule,

C2) one or more quaternary ammonium salts, and,

C3) optionally, one or more short chain diols having molecular weights of no more than 400 g/mol;

in the presence of

D) water and/or physical blowing agents;

E) catalysts; and

F) optionally, additional auxiliary substances and/or additives.

In accordance with the present invention, preferred aromatic amines to be used as component C1) which have at least 2 primary amine groups per molecule include compounds such as, for example, 1,3,5-triethyl-2,4-diaminobenzene, 1-methyl-3,5-diethyl-2,6-diaminobenzene, 1-methyl-3,5-diethyl-2,4-diaminobenzene, 3,5,3′,5′-tetraisopropyl-4,4′-diaminodiphenylmethane and 2,4-diaminomesitylene. Of course, mixtures of these aromatic amines may also be used.

Suitable quaternary ammonium salts to be used as component C2) in the present invention include those quaternary ammonium salts that are preferably built up from cations with a tetra-alkyl/aryl-ammonium structure and anions such as, for example, chloride, fluoride, bromide, sulfate, monoalkylsufate, arylsulfate, phosphate, dialkylphosphate, monoalkylphosphate, sulfonate and phosphonate. Some specific examples of suitable quaternary ammonium salts include, for example, trimethylbenzylammonium methylsulfate, trimethylbenzylammonium chloride, trimethyloctylammonium ethylsulfate, tetrabutylammonium chloride, triethylbenzylammonium diethylphosphate, trimethyldodecylammonium ethylsulfate, dimethylethyldodecylamronium ethylsulfate, tetraethylammonium chloride, tetrabutylammonium bromide, methyltrioctylammonium chloride and tetrabutylammonium diethylphosphate.

In general, the aromatic amine chain extenders C1) are preferably used in amounts of 1 to 15% by weight, and more preferably 2 to 12% by weight, based on 100% of the combined weight of the sum of components B), C), D) and E).

The quaternary ammonium salts C2) are preferably used in amounts of 0.25 to 12% by weight, and more preferably in amounts of 0.5 to 8% by weight, based on 100% of the combined weight of components B), C), D) and E).

Water, although optional, is preferably used as component D), and is preferably present in amounts of 0.01 to 0.8%, and more preferably 0.1 to 0.6%, based on 100% of the combined weight of components B), C), D) and E).

The cellular polyurethane elastomers of the present invention preferably have a free foam bulk density of 250 to 800 kg/m³ and may be compacted to give molded foam parts with a bulk density of 300 to 900 kg/m³. The hardness of the PU elastomers is preferably 45 to 70 Shore A.

Any physical blowing agent or mixture of blowing agents can be used as the blowing agent. Suitable compounds to be used as blowing agents include, for example, those based on hydrocarbons (e.g. butane, iso-butane, n-pentane, iso-pentane, cyclopentane, n-hexane, iso-hexane, cyclohexane), chlorofluorocarbons (such as e.g. Freon R 141b), and fluorocarbons (such as e.g. 134a, R365mfc and R227ea), and mixtures of these. The blowing agents can be encapsulated in polymeric microspheres (expandable plastic hollow microspheres filled with blowing agents, e.g. iso-butane).

Polyether polyols, polyester polyols and mixtures of these are used as component B). The polyether polyols preferably contain at least 80% of primary OH groups and preferably have an OH value of 18-112. The suitable polyester polyols preferably have an OH value of 28-112.

Polyisocyanates or polyisocyanate prepolymers based on liquefied MDI products (diisocyanatodiphenylmethane=MDI) are preferred as component A).

The cellular amine-crosslinked polyurethane elastomers according to the invention have exceptional mechanical properties over a wider range of operating temperatures, when compared with glycol-crosslinked polyurethane elastomers.

The cellular polyurethane elastomers (PUR foams) of the present invention may be prepared, for example, by the generally known processes including, for example, by manual processing, by means of low-pressure machines or, preferably, high-pressure machines, or in the RIM process in open or closed molds, including, for example, metallic molds. Closed molds in the RIM process are preferred. Soles of shoes, e.g., may thus be produced in a single or multilayered manner, and then the corresponding shoes can be produced by means of a direct soling process.

The cellular elastomers of the present invention, which exhibit very good low-temperature properties, due to a very low glass transition temperature, and heat-resistance up to about 160° C. under continuous use are suitable for use in, for example, shoe sole applications.

The parts of shoes, and particularly soles of shoes, are preferably produced in a 2-component low-pressure or high-pressure unit.

The invention will be described in more detail in the following examples.

### EXAMPLES

The following starting materials were used in the working examples:

| | |
|---|---|
| Polyether B1: | A polyether polyol having an OH value of 28, |
| | a functionality of 2, and containing 90% of primary |
| | OH groups; obtained by the addition of 80% |
| | propylene oxide (PO) and 20% ethylene oxide |
| | (EO) to propylene glycol as a starter. |
| Polyether B2: | A polyether polyol having an OH value of 28, |
| | a functionality of 3, and containing 90% of |
| | primary OH groups; obtained by the addition |
| | of 83% PO and 17% EO to glycerine as a starter. |
| Polyester B3: | A polyester polyol based on adipic acid, ethylene |
| | glycol, 1,4-butanediol with an OH value of 56. |
| Polyisocyanate A1: | A polyisocyanate having an NCO group content |
| | of 19.8%, was prepared by reacting 66 parts of |
| | 4,4′-MDI and 5 parts of modified MDI with a NCO |
| | content of 30 wt. %, prepared by partial |
| | carbodiimidisation, and a polyol mixture comprising |
| | 20 parts of a polyol having an OH value of 56 |
| | made from propylene glycol and propylene oxide |
| | and 3 parts of a polyol having an OH value of |
| | 56 made from trimethylolpropane and propylene |
| | oxide and 6 parts of tripropylene glycol. |
| Polyisocyanate A2: | A polyisocyanate having an NCO group content |
| | of 19.0%, was prepared by reacting 55 parts of |
| | 4,4′-MDI and 6 parts of modified MDI with a |
| | NCO content of 30 wt. %, prepared by partial |
| | carbodiimidisation, and 39 parts of a polyester |
| | polyol with an OH value of 56. |
| Aromatic amine C1: | A mixture of 80 wt. % of 2,4-diamino-3,5- |
| | diethyltoluene and 20 wt. % of 2,6-diamino-3,5- |
| | diethyltoluene. |
| Quaternary | Dimethylethyldodecylammonium ethylsulfate |
| ammonium salt C2: | |
| Quaternary | Tetrabutylammonium diethylphosphate |
| ammonium salt C2′: | |
| DABCO: | 1,4-diazabicyclo-[2.2.2]-octane |
| DBTDL: | Dibutyltin dilaurate |
| Stabiliser: | DC 193 from Air Products. |

### Processing Examples

The following formulations (Table 1) were reacted by manual processing:

TABLE 1

| | Example | | | | | | | | | | |
|---|---|---|---|---|---|---|---|---|---|---|---|
| Component | 1(C) | 2* | 3* | 4(C) | 5* | 6(C) | 7* | 8(C) | 9* | 10(C) | 11* |
| Polyether B1 | 71.5 | 71.5 | 71.5 | — | — | — | — | — | — | — | — |
| Polyether B2 | 20 | 20 | 20 | — | — | — | — | — | — | — | — |
| Polyester B3 | — | — | — | 94.4 | 94.4 | 94.4 | 94.4 | 94.4 | 94.4 | 94.4 | 94.4 |
| Aromatic amine | 8 | 8 | 8 | 5 | 5 | 5 | 5 | 5 | 5 | 5 | 5 |
| C1 | | | | | | | | | | | |
| Quaternary | — | 4 | 4 | — | 4 | — | 4 | — | 4 | — | — |
| Ammonium salt | | | | | | | | | | | |
| C2 | | | | | | | | | | | |
| Quaternary | | | | | | | | | | — | 4 |
| Ammonium salt | | | | | | | | | | | |
| C2′ | | | | | | | | | | | |
| Water | 0.4 | 0.4 | 0.1 | 0.2 | 0.2 | 0.2 | 0.2 | — | — | 0.2 | 0.2 |
| R134a | — | — | 2 | — | — | — | — | — | — | — | — |
| R365mfc/R227ea | — | — | — | — | — | 5 | 5 | 5 | 5 | — | — |
| (93:7) | | | | | | | | | | | |
| DABCO | 0.1 | 0.1 | 0.1 | 0.2 | 0.2 | 0.2 | 0.2 | 0.2 | 0.2 | 0.2 | 0.2 |
| DBTDL | 0.05 | 0.05 | 0.05 | — | — | — | — | — | — | — | — |
| Stabiliser | — | — | — | 0.2 | 0.2 | 0.2 | 0.2 | 0.2 | 0.2 | 0.2 | 0.2 |
| Polyisocyanate | 40 | 40 | 35 | — | — | — | — | — | — | — | — |
| A1 | | | | | | | | | | | |
| Polyisocyanate | — | — | — | 37 | 37 | 37 | 37 | 32 | 32 | 37 | 37 |
| A2 | | | | | | | | | | | |

(C) = comparison example;
*= example according to the invention
All data are in parts by weight.

TABLE 2

| | 1(C) | 2* | 3* | 4(C) | 5* | 6(C) | 7* | 8(C) | 9* | 10(C) | 11* |
|---|---|---|---|---|---|---|---|---|---|---|---|
| Start time [sec] | 13 | 19 | 12 | 15 | 18 | 13 | 15 | 20 | 20 | 15 | 25 |
| Setting time [sec] | 13 | 19 | 20 | 15 | 20 | 15 | 15 | 20 | 40 | 15 | 40 |
| Free bulk density | 800 | 500 | 400 | 1000 | 560 | 680 | 380 | 860 | 480 | 970 | 670 |
| [kg/m³] | | | | | | | | | | | |
| Molded foam | | | 650 | | | | 650 | | | | |
| density [kg/m³] | | | | | | | | | | | |
| Shore A hardness | | | 60 | | | | 60 | | | | |

It can be seen from Examples 1, 4, 6, 8 and 10 that water and water/blowing agent mixtures provide only a small contribution to the bulk density in these formulations. Only the use of the combination according to the invention, of aromatic amines and quaternary ammonium salts, leads to the formation of CO₂ and to foams, which is obvious from the drop in bulk density, and thus produces a great improvement in blowing agent yield.

This effect is especially clear in Example 5 as compared with Example 4. When compared to Example 4, the bulk density in Example 5 is lower by a factor of almost 2. Also surprising, is the fact that a substantially better blowing agent yield is produced in Example 9 than in Example 8 when using physical blowing agents. In Example 9, the bulk density is also lower by a factor of almost 2 when compared with Example 8.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Cellular amine-crosslinked polyurethane elastomers comprising the reaction product of:
A) one or more compounds from the group consisting of polyisocyanates, polyisocyanate prepolymers, modified polyisocyanates and mixtures thereof with
B) one or more polyols selected from the group consisting of polyetherpolyols, polyesterpolyols and mixtures thereof, and
C) one or more chain-extenders comprising a mixture of:
C1) one or more aromatic amines having at least two primary amine groups per molecule,
C2) one or more quaternary ammonium salts, and
C3) optionally, one or more short-chain diols having a molecular weight of no more than 400 g/mol;
in the presence of
D) water and/or physical blowing agents,
E) catalysts, and
F) optionally, additional auxiliary substances and/or additives.

2. A process for preparing cellular amine-crosslinked polyurethane elastomers, comprising reacting
A) one or more compounds from the group consisting of polyisocyanates, polyisocyanate prepolymers and modified polyisocyanates, with
B) one or more compounds selected from the group consisting of polyether polyols, polyester polyols and mixtures thereof, and
C) one or more chain-extenders comprising a mixture of:
C1) one or more aromatic amines with at least 2 primary amine groups per molecule,
C2) one or more quaternary ammonium salts, and
C3) optionally, one or more short-chain diols with molecular weights of no more than 400 g/mol;
in the presence of
D) water and/or physical blowing agents,
E) catalysts, and
F) optionally, additional auxiliary substances and/or additives.

3. A molded article comprising a cellular polyurethane elastomer, and comprising the reaction product of:
A) one or more compounds selected from the group consisting of polyisocyanates, polyisocyanate prepolymers, modified polyisocyanates and mixtures thereof; with
B) one or more polyols selected from the group consisting of polyether polyols, polyester polyols and mixtures thereof;
C) one or more chain extenders comprising a mixture of:
C1) one or more aromatic amines with at least 2 primary amine groups per molecule,
C2) one or more quaternary ammonium salts, and
C3) optionally, one or more short-chain diols with molecular weights of no more than 400 g/mol; in the presence of
D) water and/or physical blowing agents,
E) catalysts, and
F) optionally, additional auxiliary substances and/or additives.
